(19) United States
(12) Patent Application Publication
(10) Pub. No.: US 2022/0152936 A1
(43) Pub. Date: May 19, 2022

(54) GENERATING THERMAL IMAGES

(71) Applicant: Hewlett-Packard Development Company, L.P., Spring, TX (US)

(72) Inventors: He Luan, Palo Alto, CA (US); Jun Zheng, Palo Alto, CA (US); Carlos Alberto Lopez-Collier de la Marliere, Guadalajara (MX)

(73) Assignee: Hewlett-Packard Development Company, L.P., Spring, TX (US)

(21) Appl. No.: 17/415,178

(22) PCT Filed: Jul. 31, 2019
(86) PCT No.: PCT/US2019/044321

§ 371 Date: Jun. 17, 2021

(51) Int. Cl. B29C 64/393; G06T 5/50; G06F 30/27

(52) U.S. Cl. CPC B29C 64/393; B33Y 50/02; G06F 30/27; G06T 5/50

(57) ABSTRACT

Examples of methods generated thermal images are described. In some examples, a method may include simulating three-dimensional (3D) manufacturing to produce a simulated thermal image at a first resolution. In some examples, the method may include generating a thermal image at a second resolution based on the simulated thermal image. In some examples, the second resolution is greater than the first resolution.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final part. In some additive manufacturing techniques, the build material may be cured or fused.

### BRIEF DESCRIPTION OF THE DRAWINGS

FIG. 1 is a simplified isometric view of an example of a three-dimensional (3D) printing device that may be used in an example of generating thermal images;

FIG. 2 is a block diagram illustrating examples of functions that may be implemented for generating thermal images;

FIG. 3 is a block diagram of an example of an apparatus that may be used in generating thermal images;

FIG. 4 is a flow diagram illustrating an example of a method for generating thermal images;

FIG. 5 is a flow diagram illustrating an example of a method for generating thermal images; and

FIG. 6 is a simplified perspective view of an example of visualizations of simulation results in accordance with some examples of the techniques described herein.

### DETAILED DESCRIPTION

Additive manufacturing may be used to manufacture three-dimensional (3D) objects. 3D printing is an example of additive manufacturing. Some examples of 3D printing may selectively deposit agents (e.g., droplets) at a pixel level to enable control over voxel-level energy deposition. For instance, thermal energy may be projected over material in a build area, where a phase change (for example, melting and solidification) in the material may occur depending on the voxels where the agents are deposited.

A voxel is a representation of a location in a 3D space. For example, a voxel may represent a volume or component of a 3D space. For instance, a voxel may represent a volume that is a subset of the 3D space. In some examples, voxels may be arranged on a 3D grid. For instance, a voxel may be rectangular or cubic in shape. Examples of a voxel size dimension may include 25.4 millimeters (mm)/150≈170 microns for 150 dots per inch (dpi), 490 microns for 50 dpi, 2 mm, etc. The term “voxel level” and variations thereof may refer to a resolution, scale, or density corresponding to voxel size. In some examples, the term “voxel” and variations thereof may refer to a “thermal voxel.” In some examples, the size of a thermal voxel may be defined as a minimum that is thermally meaningful (e.g., greater than or equal to 42 microns or 600 dots per inch (dpi)). A set of voxels may be utilized to represent a build volume. A build volume is a volume in which an object or objects may be manufactured. A “build” may refer to an instance of 3D manufacturing.

In some examples of 3D manufacturing (e.g., Multi Jet Fusion (MJF)), each voxel in the build volume may undergo a thermal procedure (approximately 15 hours of build time (e.g., time for layer-by-layer printing) and approximately 35 hours of additional cooling). The thermal procedure of voxels that include an object may affect the manufacturing quality (e.g., functional quality) of the object.

Thermal sensing may provide an amount of thermal information (e.g., a relatively small amount of spatial thermal information of the build volume and/or a relatively small amount of temporal thermal information over about 50 hours of build and cooling). For example, a thermal sensor (e.g., camera, imager, etc.) may capture about 10 seconds of a thermal voxel's 50-hour procedure when the voxel is exposed as part of a fusing layer, thereby resulting in a lack of temporal coverage. Thermal sensors at the walls and bottom of the build volume may report transient temperatures of a few selected spots, thereby resulting in a lack of spatial coverage.

Some theory-based simulation approaches (e.g., simulations based on thermodynamics laws) may provide additional spatial and temporal information for the thermal procedure (e.g., manufacturing). However, some types of simulations may be computationally expensive, where it may be difficult to achieve a discrete resolution near a print resolution. An example of print resolution is 42 microns in x-y dimensions and 80 microns in a z dimension. It may be beneficial to provide thermal information at or near print resolution (e.g., 75 dpi) for guiding the placement of an agent or agents (e.g., fusing agent, detailing agent, and/or other thermally relevant fluids). In some examples, there is a sizable gap between the resolutions that process simulation can afford (e.g., approximately 15 dpi) and a print resolution (e.g., approximately 75 dpi in x-y dimensions and 320 dpi in the z dimension).

Some examples of the techniques described herein may utilize a machine learning model or models (e.g., deep learning) to overcome the resolution gap. In some examples, this may enable process simulation results to be utilized for printer operational management. For instance, some of the techniques described herein provide approaches to enhance the resolution of thermal information provided by a simulation. For example, machine learning (e.g., deep learning, neural network(s), etc.) may be applied to enhance resolution of the thermal information. Some examples of machine learning models, once trained, may operate relatively quickly (e.g., on the order of 100 milliseconds per print layer). Accordingly, resolution enhancement may be performed without adding a significant or large amount of computational cost. Examples of the machine learning models described herein may include neural networks, deep neural networks, spatio-temporal neural networks, etc.

In some examples, thermal information or thermal behavior may be mapped as a thermal image. A thermal image is a set of data indicating temperature(s) (or thermal energy) in an area. A thermal image may be sensed, captured, simulated, and/or enhanced.

The terms “low resolution” and “high resolution” are utilized herein, where “high resolution” denotes a resolution that is greater than “low resolution.” In some examples, low resolution may refer to a resolution that is less than or equal to 50 dpi (e.g., 25 dpi, 12 dpi, 1 mm voxel dimension, 2 mm voxel dimension, etc.). In some examples, high resolution may refer to a resolution that is greater than 50 dpi (e.g., 150 dpi, 0.17 mm voxel dimension, 0.08 voxel dimension, etc.).

A “simulation voxel” is a discrete volume used for simulation. Simulation voxel size may be set in accordance with a target resolution. For example, simulation voxel size may be set to a print resolution (e.g., approximately the same size as a voxel size for printing), or may be set to be larger for a lower resolution in simulation. In some examples, voxels or simulation voxels may be cubic or rectangular prismatic. An example of three-dimensional (3D) axes includes an x dimension, a y dimension, and a z dimension. In some examples, a quantity in the x dimension may be referred to as a width, a quantity in the y dimension may be referred to as a length, and/or a quantity in the z dimension may be referred to as a height. The x and/or y axes may be referred to as horizontal axes, and the z axis may be referred to as a vertical axis. Other orientations of the 3D axes may be utilized in some examples, and/or other definitions of 3D axes may be utilized in some examples.

Some examples of the techniques described herein may utilize machine learning (e.g., deep learning) to enhance the resolution of simulated thermal images. Some examples of the techniques may include approaches to create simulation results to train the machine learning model(s). Some examples of the techniques may include machine learning computational flow architectures that utilize simulation results and geometrical data (e.g., 3D model data, 2D slices, contone maps, etc.) to infer enhanced simulation results. In some examples, the machine learning computational flow may be utilized in post processing to generate high-resolution results that are at or near print resolution. In some examples, the high-resolution results may be utilized to perform print operations by a printer controller. In some examples, high-resolution results may be compared with in-line printer thermal sensing to improve and/or correct the simulation. The comparison (e.g., difference) may be applied to inform simulation tuning.

Some examples of the techniques described herein may allow process simulation beyond offline prediction, which may predict a batch's yield before printing. For instance, some examples of the techniques described may beneficially allow process simulation to be utilized in operational applications due to quantitative results with improved resolution (e.g., at or near print resolution). Some examples of the techniques described herein may be implemented in a printer operating system to provide thermal behavior prediction and/or guide thermal management at a voxel level (e.g., agent distribution).

While plastics (e.g., polymers) may be utilized as a way to illustrate some of the approaches described herein, the techniques described herein may be utilized in various examples of additive manufacturing. For instance, some examples may be utilized for plastics, polymers, semi-crystalline materials, metals, etc. Some additive manufacturing techniques may be powder-based and driven by powder fusion. Some examples of the approaches described herein may be applied to area-based powder bed fusion-based additive manufacturing, such as Stereolithography (SLA), Multi Jet Fusion (MJF), Metal Jet Fusion, Selective Laser Melting (SLM), Selective Laser Sintering (SLS), liquid resin-based printing, etc. Some examples of the approaches described herein may be applied to additive manufacturing where agents carried by droplets are utilized for voxel-level thermal modulation.

In some examples, “powder” may indicate or correspond to particles insulated with air pockets. An “object” may indicate or correspond to a location (e.g., area, space, etc.) where particles are to be sintered, melted, or solidified that is filled with the material itself without air bubbles or with small air bubbles. For example, an object may be formed from sintered or melted powder.

Throughout the drawings, identical or similar reference numbers may designate similar, but not necessarily identical, elements. When an element is referred to without a reference number, this may refer to the element generally, without necessary limitation to any particular Figure. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

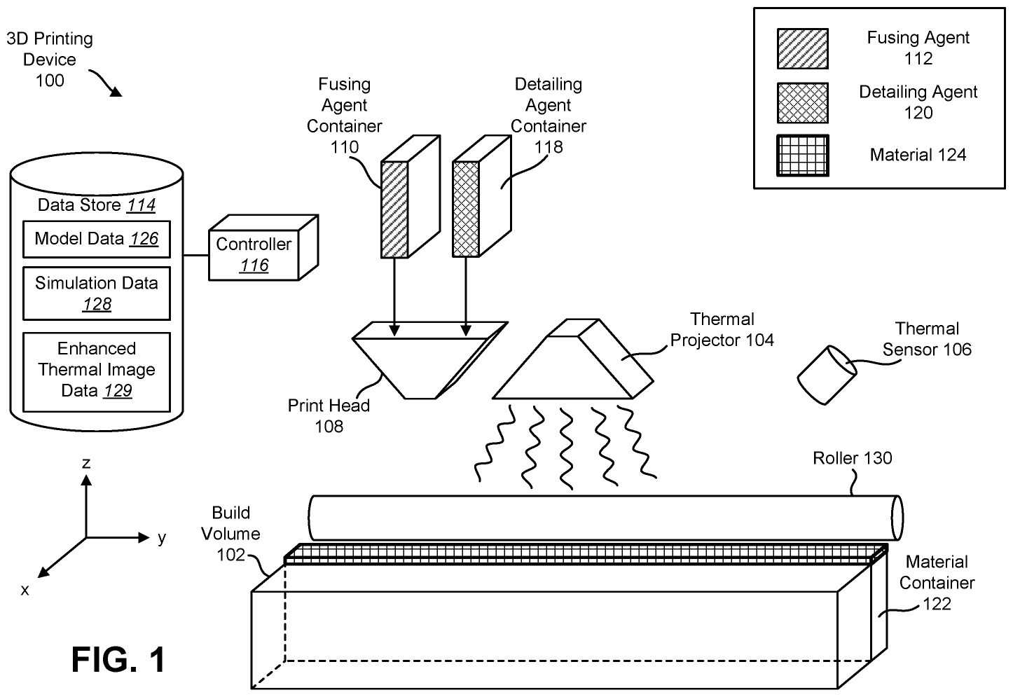

FIG. 1 is a simplified isometric view of an example of a 3D printing device 100 that may be used in an example of generating thermal images. The 3D printing device 100 may include a controller 116, a data store 114, a build volume 102, a print head 108, a fusing agent container 110, a detailing agent container 118, a roller 130, a material container 122, a thermal projector 104, and/or a thermal sensor 106. The example of a 3D printing device 100 in FIG. 1 may include additional components that are not shown, and some of the components described may be removed and/or modified without departing from the scope of the 3D printing device 100 in this disclosure. The components of the 3D printing device 100 may not be drawn to scale, and thus, may have a size and/or implementation different than what is shown.

In the example of FIG. 1, the 3D printing device 100 includes a fusing agent container 110, fusing agent 112, a detailing agent container 118, detailing agent 120, a material container 122, and material 124. In other examples, the 3D printing device 100 may include more or fewer containers, agents, hoppers, and/or materials. The material container 122 is a container that stores material 124 that may be applied (e.g., spread) onto and/or into the build volume 102 by the roller 130 for 3D printing. The fusing agent container 110 is a container that stores a fusing agent 112. The fusing agent 112 is a substance (e.g., liquid, powder, etc.) that controls intake thermal intensity. For example, the fusing agent 112 may be selectively applied to cause applied material 124 to change phase with heat applied from the thermal projector 104 and/or to fuse with another layer of material 124. For instance, areas of material 124 where the fusing agent 112 has been applied may eventually solidify into the object being printed. The detailing agent 120 is a substance (e.g., liquid, powder, etc.) that controls outtake thermal intensity. For example, the detailing agent 120 may be selectively applied to detail edges of the object being printed. A “layer” or “print layer” refers to a layer of material for manufacturing an object or objects or to data representing a layer of material. A fusing layer is an exposed layer, a top layer, or a layer undergoing fusing of material. For example, a fusing layer may be a top layer of material that is exposed to the print head 108 and/or thermal projector 104. A buried layer is a covered layer or is a layer under the fusing layer.

The build volume 102 is a volume in which additive manufacturing may be performed. In the example illustrated in FIG. 1, the build volume 102 is rectangular and is partially enclosed with five surfaces: a bottom surface, a front surface, a back surface, a left surface, and a right surface. Other shapes and/or numbers of surfaces may be implemented in other examples. For example, the build volume may be cubic, prismatic, polygonal, curved, elliptical, spherical, etc. A surface is matter that encloses a build volume. For example, a surface may be metal, plastic, and/or other matter that forms an edge of a build volume. In some examples, the bottom surface may be movable. For example, the bottom surface may be lowered as additional layers of material are applied to the build volume 102.

The roller 130 is a device for applying material 124 to the build volume 102. In order to print a 3D object, the roller 130 may successively apply (e.g., spread) material 124 (e.g., a powder) and the print head 108 may successively apply and/or deliver fusing agent 112 and/or detailing agent 120. The thermal projector 104 is a device that delivers energy (e.g., thermal energy, heat, etc.) to the material 124, fusing agent 112, and/or detailing agent 120 in the build volume 102. For example, fusing agent 112 may be applied on a material 124 layer where particles (of the material 124) are meant to fuse together. The detailing agent 120 may be applied to modify fusing and create fine detail and/or smooth surfaces. The areas exposed to energy (e.g., thermal energy from the thermal projector 104) and reactions between the agents (e.g., fusing agent 112 and detailing agent 120) and the material 124 may cause the material 124 to selectively fuse together to form the object.

The print head 108 is a device to apply a substance or substances (e.g., fusing agent 112 and/or detailing agent 120). The print head 108 may be, for instance, a thermal inkjet print head, a piezoelectric print head, etc. The print head 108 may include a nozzle or nozzles (not shown) through which the fusing agent 112 and/or detailing agent 120 are extruded. In some examples, the print head 108 may span a dimension of the build volume 102. Although a single print head 108 is depicted, multiple print heads 108 may be used that span a dimension of the build volume 102. Additionally, a print head or heads 108 may be positioned in a print bar or bars. The print head 108 may be attached to a carriage (not shown in FIG. 1). The carriage may move the print head 108 over the build volume 102 in a dimension or dimensions.

The material 124 is a substance (e.g., powder) for manufacturing objects. The material 124 may be moved (e.g., scooped, lifted, and/or extruded, etc.) from the material container 122, and the roller 130 may apply (e.g., spread) the material 124 onto the build volume 102 (on top of a current layer, for instance). In some examples, the roller 130 may span a dimension of the build volume 102 (e.g., the same dimension as the print head 108 or a different dimension than the print head 108). Although a roller 130 is depicted, other means may be utilized to apply the material 124 to the build volume 102. In some examples, the roller 130 may be attached to a carriage (not shown in FIG. 1). The carriage may move the roller 130 over the build volume 102 in a dimension or dimensions. In some implementations, multiple material containers 122 may be utilized. For example, two material containers 122 may be implemented on opposite sides of the build volume 102, which may allow material 124 to be spread by the roller 130 in two directions.

In some examples, the thermal projector 104 may span a dimension of the build volume 102. Although one thermal projector 104 is depicted, multiple thermal projectors 104 may be used that span a dimension of the build volume 102. Additionally, a thermal projector or projectors 104 may be positioned in a print bar or bars. The thermal projector 104 may be attached to a carriage (not shown in FIG. 1). The carriage may move the thermal projector 104 over the build volume 102 in a dimension or dimensions.

In some examples, each of the print head 108, roller 130, and thermal projector 104 may be housed separately and/or may move independently. In some examples, two or more of the print head 108, roller 130, and thermal projector 104 may be housed together and/or may move together. In one example, the print head 108 and the thermal projector 104 may be housed in a print bar spanning one dimension of the build volume 102, while the roller 130 may be housed in a carriage spanning another dimension of the build volume 102. For instance, the roller 130 may apply a layer of material 124 in a pass over the build volume 102, which may be followed by a pass or passes of the print head 108 and thermal projector 104 over the build volume 102.

The controller 116 is a computing device, a semiconductor-based microprocessor, a Central Processing Unit (CPU), Graphics Processing Unit (GPU), Field-Programmable Gate Array (FPGA), an application-specific integrated circuit (ASIC), and/or other hardware device. The controller 116 may be connected to other components of the 3D printing device 100 via communication lines (not shown).

The controller 116 may control actuators (not shown) to control operations of the components of the 3D printing device 100. For example, the controller 116 may control an actuator or actuators that control movement of the print head 108 (along the x-, y-, and/or z-axes), actuator or actuators that control movement of the roller 130 (along the x-, y-, and/or z-axes), and/or actuator or actuators that control movement of the thermal projector 104 (along the x-, y-, and/or z-axes). The controller 116 may also control the actuator or actuators that control the amounts (e.g., proportions) of fusing agent 112 and/or detailing agent 120 to be deposited by the print head 108 from the fusing agent container 110 and/or detailing agent container 118. In some examples, the controller 116 may control an actuator or actuators that raise and lower build volume 102 along the z-axis.

The controller 116 may communicate with a data store 114. The data store 114 may include machine-readable instructions that cause the controller 116 to control the supply of material 124, to control the supply of fusing agent 112 and/or detailing agent 120 to the print head 108, to control movement of the print head 108, to control movement of the roller 130, and/or to control movement of the thermal projector 104.

In some examples, the controller 116 may control the roller 130, the print head 108, and/or the thermal projector 104 to print a 3D object based on a 3D model. For instance, the controller 116 may utilize a contone map or maps that are based on the 3D model to control the print head 108. A contone map is a set of data indicating a location or locations (e.g., areas) for printing a substance (e.g., fusing agent 112 or detailing agent 120). In some examples, a contone map may include or indicate machine instructions (e.g., voxel-level machine instructions) for printing a substance. For example, a fusing agent contone map indicates coordinates and/or an amount for printing the fusing agent 112. In an example, a detailing agent contone map indicates coordinates and/or an amount for printing the detailing agent 120. In some examples, a contone map may correspond to a two-dimensional (2D) layer (e.g., 2D slice, 2D cross-section, etc.) of the 3D model. For instance, a 3D model may be processed to produce a plurality of contone maps corresponding to a plurality of layers of the 3D model. In some examples, a contone map may be expressed as a 2D grid of values, where each value may indicate whether to print an agent and/or an amount of agent at the location on the 2D grid. For instance, the location of a value in the 2D grid may correspond to a location in the build volume 102 (e.g., a location (x, y) of a particular level (z) at or above the build volume 102). In some examples, a contone map may be a compressed version of the aforementioned 2D grid or array (e.g., a quadtree).

The data store 114 is a computer-readable medium. Machine-readable storage is any electronic, magnetic, optical, or other physical storage device that stores executable instructions and/or data. A computer-readable medium may be, for example, Random Access Memory (RAM), an Electrically Erasable Programmable Read-Only Memory (EEPROM), a storage drive, an optical disc, and the like. A computer-readable medium may be encoded with executable instructions for controlling the 3D printing device 100. A computer-readable medium is an example of a computer-readable medium that is readable by a processor or computer.

The thermal sensor 106 is a device that senses or captures thermal data. The thermal sensor 106 may be integrated into, mounted in, and/or otherwise included in a machine (e.g., printer). In some examples, the thermal sensor 106 may capture thermal images of the build volume 102. For instance, the thermal sensor 106 may be an infrared thermal sensor (e.g., camera) that captures thermal images of the build volume 102 (e.g., applied material in the build volume 102, a fusing layer in the build volume 102). In some examples, the thermal sensor 106 may capture thermal images during manufacturing (e.g., printing). For example, the thermal sensor 106 may capture thermal images online and/or in real-time. A thermal image may be captured (e.g., sensed) from a thermal sensor 106. For example, the thermal sensor 106 may capture a thermal image of a layer to produce a captured thermal image.

In some examples, a captured thermal image may be a two-dimensional (2D) grid of sensed temperatures or thermal energy. In some examples, each location in the 2D grid may correspond to a location in the build volume 102 (e.g., a location (x, y) of a particular level (z) at or above the build volume 102). The thermal image or images may indicate thermal variation (e.g., temperature variation) over a layer or layers in the build volume 102. For example, thermal sensing over the build volume 102 may indicate (e.g., capture and encapsulate) environmental complexity and heterogeneous thermal diffusivity. In some approaches, the thermal image or images may be transformed to align with a contone map or contone maps (e.g., registered with the contone map or maps).

In some examples, the controller 116 may receive a captured thermal image of a layer from the thermal sensor 106. For example, the controller 116 may command the thermal sensor 106 to capture a thermal image and/or may receive a captured thermal image from the thermal sensor 106. In some examples, the thermal sensor 106 may capture a thermal image for each layer of an object being manufactured. The captured thermal image is at a resolution. In some examples, the resolution of the captured thermal image may be at a low resolution. Examples of low resolution include 31×30 pixels and 80×60 pixels. In some examples, a captured thermal image may be stored in the data store 114.

In some examples, the data store 114 may store model data 126, simulation data 128, and/or enhanced thermal image data 129. The simulation data 128 may include instructions for producing a simulated thermal image or simulated thermal images. In some examples, the controller 116 may execute the instructions to produce a simulated thermal image corresponding to an artificial layer. An artificial layer is an artificial combination of layers. For example, data representing multiple layers may be grouped into an artificial layer for simulation. For example, an artificial layer may correspond to multiple print layers.

The model data 126 includes data defining a model or models (e.g., machine learning model(s), neural network(s), etc.). For instance, the model data 126 may define a node or nodes, a connection or connections between nodes, a network layer or network layers, and/or a neural network or neural networks. Examples of neural networks include convolutional neural networks (CNNs) (e.g., basic CNN, deconvolutional neural network, inception module, residual neural network, etc.) and recurrent neural networks (RNNs) (e.g., basic RNN, multi-layer RNN, bi-directional RNN, fused RNN, clockwork RNN, etc.). Some approaches may utilize a variant or variants of RNN (e.g., Long Short Term Memory Unit (LSTM), peephole LSTM, no input gate (NIG), no forget gate (NFG), no output gate (NOG), no input activation function (NIAF), no output activation function (NOAF), no peepholes (NP), coupled input and forget gate (CIFG), full gate recurrence (FGR), gated recurrent unit (GRU), etc.). Different depths of a neural network or neural networks may be utilized.

In some examples, the controller 116 may use the machine learning model(s) (defined by the model data 126) to generate enhanced thermal images. An enhanced thermal image is a thermal image with a resolution that is greater than a resolution of a corresponding simulated thermal image. Resolution may refer to spatial resolution (e.g., voxel density, pixel density, etc.) and/or temporal resolution (e.g., frequency, frame rate, etc.). For example, an enhanced thermal image may have increased resolution in an x dimension, a y dimension, a z dimension, and/or a time dimension. In some examples, the controller 116 may generate a set of enhanced thermal images based on the simulated thermal image. In some examples, each of the set of enhanced thermal images may correspond to one of the multiple print layers.

In some examples, the controller 116 may generate an enhanced thermal image based on the machine learning model(s), simulated thermal image(s), captured thermal image(s), shape image data (e.g., slice(s)), and/or contone map(s) (e.g., fusing contone map(s) and detailing contone map(s)). A shape image is an image that indicates shape geometry. Examples of a shape image may include a slice or a contone map(s) (e.g., fusing agent contone map and/or detailing agent contone map). In some examples, the shape image data may be utilized as inputs to the machine learning model(s). For instance, a high-resolution contone map or maps may be used in some approaches because the contone map or maps may enable print resolution energy control and/or may provide information to generate enhanced thermal images relative to simulated thermal images.

In some examples, simulated thermal images, captured thermal images, and/or shape images may be utilized to train the machine learning model(s). For instance, the controller 116 may compute a loss function based on the simulated thermal images, captured thermal images, and/or shape images. The machine learning model(s) may be trained based on the loss function.

Some examples of machine learning models may include neural networks. In some examples, a neural network may include an input layer or layers, an encoder layer or layers, a spatiotemporal layer (e.g., RNN layer), a decoder layer or layers, and/or an output layer or layers. For example, next to the input layer, an encoder layer may extract features from inputs. The spatiotemporal layer may learn sequential and/or spatial information from simulated thermal image(s), contone map(s), and/or a captured thermal image(s). The decoder layer may translate features into an output domain and may be situated before the output layer. Each layer may include a node or nodes (e.g., more than one node (or perceptron)) in some implementations. In some examples, a neural network may be connected to another neural network or networks, may include another neural network or networks, and/or may be merged (e.g., stacked) with another neural network or networks. In some examples, another neural network or networks may be utilized as an encoder or decoder. In some examples, multiple encoders or decoders may be utilized, or an encoder or decoder may not be implemented or utilized.

In some examples, the controller 116 may print a layer or layers based on the enhanced thermal image(s). For instance, the controller 116 may control the amount and/or location of fusing agent 112 and/or detailing agent 120 for a layer based on the enhanced thermal image. In some examples, the controller 116 may drive model setting (e.g., the size of the stride) based on the enhanced thermal image (e.g., thermal diffusion). In some examples, the controller 116 may perform offline print mode tuning based on the enhanced thermal image. For example, if the enhanced thermal image indicates systematic bias (e.g., a particular portion of the build area is consistently colder or warmer than baseline), the data pipeline may be altered such that the contone maps are modified to compensate for such systematic bias. For instance, if the enhanced thermal image indicates a systematic bias, the controller 116 may adjust contone map generation (for a layer or layers, for example) to compensate for the bias. Accordingly, the location and/or amount of agent(s) deposited may be adjusted based on the contone map(s) to improve print accuracy and/or performance.

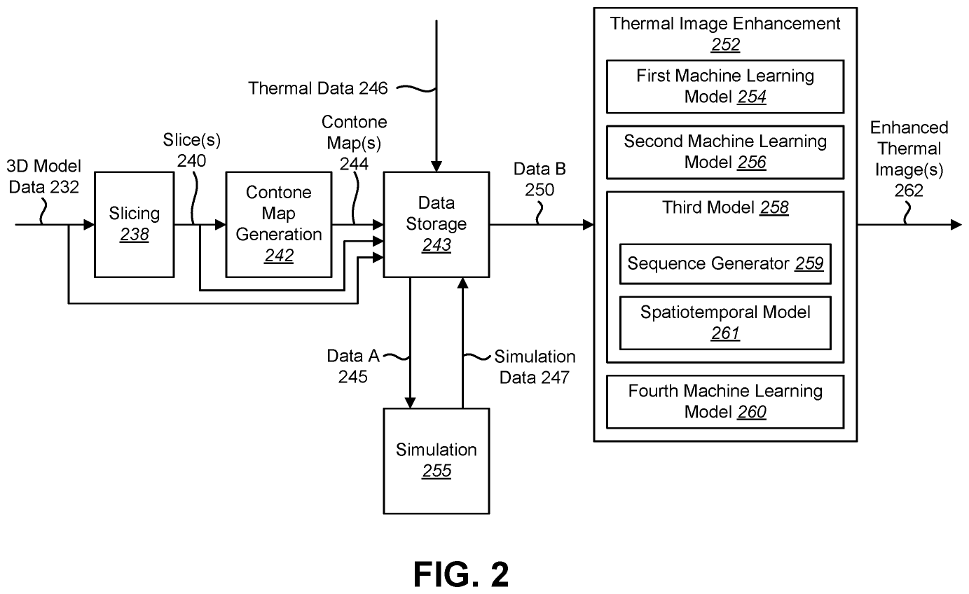

FIG. 2 is a block diagram illustrating examples of functions that may be implemented for generating thermal images. In some examples, one, some, or all of the functions described in connection with FIG. 2 may be performed by the controller 116 described in connection with FIG. 1. For instance, instructions for slicing 238, contone map generation 242, data storage 243, thermal image enhancement 252, and/or simulation 255 may be stored in the data store 114 and executed by the controller 116 in some examples. In other examples, a function or functions (e.g., slicing 238, contone map generation 242, data storage 243, thermal image enhancement 252, and/or simulation 255) may be performed by another apparatus. For instance, slicing 238 may be carried out on a separate apparatus and sent to the 3D printing device 100.

3D model data 232 may be obtained. For example, the 3D model data 232 may be received from another device and/or generated. The 3D model data 232 may specify shape and/or size of a 3D model for printing a 3D object or objects. 3D model data 232 can define both the internal and the external portion of the 3D object. The 3D model data 232 can be defined, for example, using polygon meshes. For example, the 3D model data 232 can be defined using a number of formats such as a 3D manufacturing format (3MF) file format, an object (OBJ) file format, and/or a stereolithography (STL) file format, among other type of file formats. In some examples, the 3D model data may be referred to as a “batch.” In some examples, the 3D model data 232 may be provided to data storage 243.

Slicing 238 may be performed based on the 3D model data 232. For example, slicing 238 may include generating a set of 2D slices 240 corresponding to the 3D model data 232. In some approaches, the 3D model indicated by the 3D model data 232 may be traversed along an axis (e.g., a vertical axis, z-axis, or other axis), where each slice 240 represents a 2D cross section of the 3D model. For example, slicing 238 the 3D model can include identifying a z-coordinate of a slice plane. The z-coordinate of the slice plane can be used to traverse the 3D model to identify a portion or portions of the 3D model intercepted by the slice plane. In some examples, the slices 240 may be provided to data storage 243.

A 3D model and/or stack of 2D slices (e.g., vector slices) may be utilized to generate per-layer machine instructions (e.g., voxel-level agent distribution) by accounting for process physics. Contone maps may be examples of per-layer machine instructions. In some examples, contone map generation 242 may be performed based on the slices 240. For example, a contone map or contone maps 244 may be generated for each slice 240. For instance, contone map generation 242 may include generating a fusing contone map and/or a detailing contone map, where the fusing contone map indicates an area or areas and density distribution for printing fusing agent for a layer. The detailing contone map indicates an area or areas and density distribution for printing detailing agent for the layer. The contone map or maps 244 may be represented in a variety of file formats in some examples. For instance, a contone map 244 may be formatted as an image file and/or another kind of contone file. In some examples, a function or functions described in connection with FIG. 2 may be performed by a printer. For example, 3D model data 232 may be loaded onto a printer, which may perform a function or functions described in connection with FIG. 2. In some examples, slicing 238 and/or contone map generation 242 may include using instructions to voxelize and/or rasterize the 3D model data 232 (e.g., geometry) and generating agent dispensing maps (e.g., fusing agent and/or detailing agent contone map(s) 244) for a build.

The contone map(s) 244, slices 240, and/or thermal data 246 (e.g., measurement(s)) may be stored using a data storage 243 function. For example, the contone map(s) 244, slices 240, and/or thermal data 246 may be stored (in a database, for instance) in a storage device.

In some examples, the thermal data 246 may include a measurement or measurements from a thermal sensor or sensors. In some examples, the thermal data 246 may include a timestamp or timestamps corresponding to the measurement(s). In some examples, a printer may write thermal data 246 into a database. The thermal sensor(s) may report a timestamp and thermal image periodically (e.g., at a frame rate).

Data storage 243 may provide data A 245 to the simulation 255 function. For example, simulation 255 may utilize 3D model data 232, slice(s) 240, and/or contone maps 244 to simulate the thermal behavior of a layer or layers of 3D manufacturing. In some examples, the simulation 255 may simulate 3D manufacturing to produce simulation data 247. In some examples, the simulation data 247 may include a simulated thermal image or images. For example, the simulation 255 may simulate 3D manufacturing to produce a simulated thermal image at a first resolution. In some examples, the simulation data 247 may be stored by data storage 243.

In some examples, in an x-y plane, the simulation 255 may produce a simulated thermal image with a resolution between 25 dots-per-inch (dpi) and 12 dpi (e.g., with simulation voxel sizes between 1 millimeter (mm) and 2 mm). The simulation data 247 may include the simulated thermal image.

In some examples, in the Z dimension, the simulation 255 may group multiple print layers into an artificial print layer. In some examples, a print layer may have a thickness of 0.08 mm. For instance, the simulation 255 may utilize a 2 mm simulation voxel that groups 25 print layers. While examples that utilize 25 layers are described herein, other examples may utilize other numbers of layers.

In some examples, simulation 255 complexity may arise in the time domain. A time T is a production time for a layer or an amount of time for printing a layer. Examples of T for MJF printing include approximately 7 seconds and approximately 10 seconds. In some examples of the simulation 255, simulated printing of each artificial layer may utilize an amount of time equal to a total of the printing times for the layers included in the artificial layer. For example, a 2 mm thick artificial layer may utilize 25*T for simulated layer printing.

As described above, the data storage 243 may store the simulation data 247 provided by the simulation 255. In some examples, the simulation data 247 may be stored as a simulated thermal image for each simulation time interval and for each artificial layer. In some examples, an image may be black for a layer or layers that are not yet simulated as printed.

The data storage 243 may provide data B 250 to the thermal image enhancement 252 function. In some examples, data B 250 may include simulated thermal image(s), thermal image(s) (e.g., thermal image(s) captured by a thermal sensor or sensors), contone map(s) 244, slice(s) 240, and/or 3D model data 232. In some examples, the thermal image enhancement 252 may query the data storage 243. For example, the thermal image enhancement 252 may retrieve data B 245 from a database on demand. For instance, data B 250 may include a simulated thermal image for a layer L at time t.

The thermal image enhancement 252 may produce an enhanced thermal image 262 or enhanced thermal images 262. For example, the enhanced thermal image 262 may be a thermal image with a second resolution that is greater than a first resolution of a corresponding simulated thermal image. For instance, a simulated thermal image may have a first resolution in x and y dimensions. The simulated thermal image may be enhanced to produce an enhanced thermal image with a second resolution that is greater in x and y dimensions.

In some examples, a simulated thermal image may have a first resolution in a z dimension. The simulated thermal image may be enhanced to produce an enhanced thermal image with a second resolution that is greater in the z dimension. For example, a simulated thermal image may correspond to a number of print layers, and may be enhanced to produce a number of enhanced thermal images that is equal to or greater than a corresponding number of print layers (e.g., 25 print layers). For instance, one simulated thermal image may represent a simulated layer. The simulated thermal image may be enhanced to convert the simulated thermal image into a sequence of 25 enhanced thermal images corresponding to print layers to account for variations of object(s) from print layer to print layer.

In some examples, a simulated thermal image may be enhanced in the time domain to produce enhanced thermal images 262 at a greater temporal resolution (e.g., frequency or frame rate) than that of the corresponding simulated thermal image. For instance, for fusing layers, a temporal resolution based on T may be utilized (rather than 25*T, for example). The following example is given to illustrate increasing temporal and z dimension resolution. In this example, one thermal image describes a fusing layer thermal state (e.g., a segmented thermal image in a printer log). To replicate temporal and z dimension resolution at the level of the thermal image, one simulated thermal image of an artificial layer may be enhanced to produce 25*25=625 enhanced thermal images. For each of 25 print layers, for instance, the thermal image enhancement 252 may generate 25 sequential enhanced thermal images 262 corresponding to 25 sequential timestamps (e.g., 0*T, 1*T, . . . , 24*T). In this example, the thermal image is a still thermal image that represents one layer. A similar approach may be applied in cases where thermal images are frames of a thermal video (e.g., printer logs of a thermal sense) utilized to describe the thermal state of a print layer.

In some examples, the thermal image enhancement 252 may process simulated thermal images corresponding to different layers differently based on location. For instance, the thermal image enhancement 252 may process a simulated thermal image corresponding to a fusing layer (e.g., exposed layer, top layer) differently than simulated thermal images corresponding to buried layers. In some examples, the thermal image enhancement 252 may utilize different machine learning models based on whether a simulated thermal image corresponds to a fusing layer or a buried layer.

In some examples, the thermal image enhancement 252 may include a first machine learning model 254, a second machine learning model 256, a third model 258, and/or a fourth machine learning model 260. In some examples, a simulated thermal image may correspond to an artificial layer (e.g., an artificial fusing layer) that corresponds to a fusing layer (e.g., exposed layer, top layer). For example, an artificial fusing layer may correspond to the fusing layer and buried layers that are not at the top of the artificial fusing layer. In some examples, the first machine learning model 254 and the fourth machine learning model 260 may be utilized to enhance simulated thermal images corresponding to the artificial fusing layer.

In some examples, for the artificial fusing layer that is exposed (e.g., that corresponds to the fusing layer), the first machine learning model 254 may be a deep learning model used to generate an enhanced thermal image 262 (e.g., predicted thermal image) corresponding to the fusing layer. Print layers that are not at the top of the artificial fusing layer may be buried. In some examples, the fourth machine learning model 260 may be utilized to generate (e.g., predict) enhanced thermal images 262 corresponding to buried layers of the artificial fusing layer. The enhanced thermal images 262 corresponding to buried layers may indicate the thermal behavior of the buried layers. In some examples, T may be utilized as a temporal resolution for enhanced thermal images 262 corresponding to the fusing layer and buried layers generated from the artificial fusing layer. For example, using T as the temporal resolution may enable indicating thermal behavior that may change relatively quickly in layers corresponding to the artificial fusing layer.

In some examples, the first machine learning model 254 may be utilized to increase resolution for a simulated thermal image corresponding to the fusing layer. For instance, the first machine learning model may be a fusing layer thermal behavior prediction model. In some examples, the first machine learning model 254 may utilize a sequence of thermal images and a sequence of contone maps 244. For example, the sequence of thermal images may be high-resolution thermal images of layers L−n, . . . , L−2, L−1, L, when each is a fusing layer. The sequence of contone maps 244 may be high-resolution fusing agent and/or detailing agent contone maps of each layer. The first machine learning model 254 may generate (e.g., predict) an enhanced thermal image 262 (e.g., high-resolution thermal image) of layer L+1 for when layer L+1 is a fusing layer. In some examples, the first machine learning model 24 may be trained with simulated thermal images.

In some examples, the fourth machine learning model 260 may be utilized to increase resolution for a simulated thermal image corresponding to a buried layer of an artificial fusing layer. For example, the fourth machine learning model 260 may be a buried layer thermal behavior prediction model. For instance, the fourth machine learning model 160 may predict the thermal behavior of a buried layer in time. For example, for layer 2000 in a build, the fourth machine learning model 260 may predict thermal behavior starting once the layer 2000 is printed (e.g., after layer 2000 is the fusing layer), and may predict the thermal behavior of the layer in time, when another layer or layers are printed and the layer becomes a buried layer. In some examples, the fourth machine learning model may predict the thermal behavior in time with a time interval T.

The thermal behavior of a fusing layer may continue to change when that layer becomes a buried layer. The thermal behavior of the layer may tend to stabilize after an amount of time. Accordingly, the fourth machine learning model 260 may be utilized to generate enhanced thermal images 262 (e.g., high resolution thermal images in x, y, and z dimensions) for buried layers corresponding to an artificial fusing layer.

For example, in the simulation 255 if the layer thickness is 25 times the thickness of a printed layer, and if the layer printing time is 25 times the layer production time (i.e., 25*T), the thermal image enhancement 252 may perform the following in the examples: for time T, the thermal image enhancement 252 may utilize the first machine learning model 254 to generate (e.g., predict) an enhanced thermal image 262 that indicates the fusing layer thermal behavior of layer 1. For time 2T, the thermal image enhancement 252 may utilize the first machine learning model 254 to generate (e.g., predict) an enhanced thermal image 262 that indicates the fusing layer thermal behavior of layer 2, and may utilize the fourth machine learning model 260 to generate (e.g., predict) an enhanced thermal image 262 that indicates the buried layer thermal behavior of layer 1. For time 3T, the thermal image enhancement 252 may utilize the first machine learning model 254 to generate (e.g., predict) an enhanced thermal image 262 that indicates the fusing layer thermal behavior of layer 3, and may utilize the fourth machine learning model 260 to generate (e.g., predict) an enhanced thermal image 262 that indicates the buried layer thermal behavior of layer 1 and layer 2. This procedure may iterate or recursively repeat until time 25*T.

In some examples, the fourth machine learning model 260 may be a one-time-interval ahead predictor, which may predict an enhanced thermal image 262 of a specific layer L at a next time t+dt, conditioned on a first thermal image of layer L at time t (e.g., current time t); and a second thermal image of neighboring layers (e.g., a layer L+1 above L, and a layer L−1 underneath L) at time t. In some examples, the first thermal image and the second thermal image may separately travel through two encoder neural networks to generate feature maps, which may be fed into another prediction network to predict the enhanced thermal image 262 of layer L at time t+dt. In some examples, the time interval dt may be T (e.g., a production time). In some examples, a contone map or maps (e.g., fusing agent contone map and/or detailing agent contone map) may be utilized to provide more information with the second thermal image to improve prediction.

In some examples, an image sequence or sequences may be utilized to predict an enhanced thermal image or images 262. For example, the fourth machine learning model 260 may predict the enhanced thermal image 262 of a layer L at a subsequent (e.g., next) time t+dt, conditioned on a sequence of thermal images of layer L at previous times (e.g., previous times t−n*dt, . . . , t−2*dt, t−dt, t) and a thermal image or images layer(s) above and/or below layer L. For example, the enhanced thermal image of layer L may be predicted based on a neighboring layer or layers, such as L+1, L+2, . . . above layer L, the fusing layer, and/or L−1, L−2, . . . , L−n below layer L at time t. In some examples, the fourth machine learning model 260 may include two encoder networks that are sequential models (e.g. spatiotemporal models).

In some examples, a simulated thermal image may correspond to a buried artificial layer that corresponds to buried layers. For example, a buried artificial layer may be below an artificial fusing layer and/or may correspond to buried layers that are below the artificial fusing layer. In some examples, the second machine learning model 256 and/or the third model 258 may be utilized to enhance (e.g., increase the resolution of) simulated thermal images corresponding to a buried artificial layer.

The second machine learning model 256 is a machine learning model that increases the resolution of a simulated thermal image. In some examples, the second machine learning model 256 may be utilized to increase resolution for a simulated thermal image corresponding to a buried layer. For example, the second machine learning model 256 may utilize a low-resolution (e.g., 25 dpi) simulated thermal image and a high-resolution (e.g. 150 dpi) shape image (e.g., slice 240 and/or contone map(s) 244) as input to produce an enhanced thermal image 262. For instance, the second machine learning model 256 may provide a high-resolution (e.g., 150 dpi) thermal image. Examples of a shape image may include a slice 240 or a contone map(s) 244 (e.g., fusing agent contone map and/or detailing agent contone map). In some examples, the second machine learning model 256 may be trained with low-resolution simulated thermal image(s), high-resolution simulated thermal image(s), and high-resolution shape image(s) (e.g., slice(s) 240 and/or contone map(s) 244). In some examples, the second machine learning model 256 may be a neural network or neural networks.

The third model 258 is a model that generates a sequence of images from a thermal image corresponding to a buried artificial layer. For example, the third model 258 may be an image-to-video translation model that utilizes a simulated thermal image corresponding to one artificial layer and a sequence of shape images (e.g., slices 240 and/or contone maps 244) to produce a sequence of simulated thermal images corresponding to print layers. The sequence of shape images may provide the structural information for the thermal images. In some examples, the third model 258 may include a numerical (e.g., bi-cubic) interpolation model and/or machine learning model (e.g., deep learning model). For example, the third model 258 may translate one simulated thermal image, which may be defined at a center of a buried artificial layer in the z dimension, into a sequence of simulated thermal images defined at different heights corresponding to print layers. In some examples for buried layers, a time resolution of T may be utilized. Other examples of time resolutions (e.g., 25*T) may be utilized. For instance, some of the examples below utilize 25*T.

In some examples, the third model 258 may include a sequence generator 259 that generates individual simulated thermal images in the sequence of simulated thermal images (e.g., 25 layers) from a simulated thermal image. Generating the simulated thermal images may be conditioned on sequence of shape images (e.g., 25 layers). In some examples, the third model 258 may include a spatiotemporal model 261 that refines spatial and temporal correlation features in the simulated thermal images and generates a sequence of simulated thermal images (e.g., 25 layers) with spatiotemporal information at different heights (e.g., in the z dimension). A feature is a measurement of a correlation or relationship between neighboring voxels, or is a measurement of a characteristic or property (or properties) of an observed phenomenon. Spatial features are features in a spatial dimension or dimensions (e.g., shapes). For example, spatial features may vary over the spatial dimension(s). Temporal features are features in a time dimension. For example, temporal features may vary over time. The spatiotemporal information of the simulated thermal images may include thermal information (e.g., temperatures) in spatial and temporal dimensions.

In some examples, the second machine learning model 256 and third model 258 may be modeled separately (e.g., individually) or together. For instance, the second machine learning model 256 may be implemented as part of the spatiotemporal model of the third model 258. In some examples, the second machine learning model 256 and the third model 258 may be implemented as a combination model that generates enhanced thermal images 262 (e.g., high-resolution thermal images) in x-y and z directions, from a low-resolution simulated thermal image in x-y and z directions.

In some examples, the thermal image enhancement 252 may receive data B 250. In a case that data B 250 includes data for a future layer, the thermal image enhancement 252 may not produce an output for that layer. For instance, if t<L*T (e.g., where an image is black), the thermal image enhancement 252 may not produce an output.

In some examples, in a case that data B 250 includes a simulated thermal image for an artificial buried layer (e.g., if t>L*T), the thermal image enhancement 252 may apply the third model 258 to generate a low-resolution simulated thermal image for each print layer. Thermal image enhancement 252 may apply the second machine learning model 256 to each of the low-resolution simulated thermal images (corresponding to each of the print layers, for instance) to produce the enhanced thermal images 262. For example, the thermal image enhancement 252 may output K high-resolution thermal images, where each thermal image is a result for a print layer at time t. In some examples, the second machine learning model 256 may include a numerical (e.g., bi-cubic) interpolation model and/or a deep learning model used to increase resolution. For instance, the second machine learning model 256 may be utilized to translate a low-resolution (e.g., approximately 25 dpi to 12 dpi) simulated thermal image into a high resolution or approximately print resolution enhanced thermal image. For example, the second machine learning model may enhance a simulated thermal image between approximately 25 dpi to 12 dpi to an enhanced thermal image at approximately 150 dpi or a voxel size of 0.17 mm (e.g., approximately a 5 to 10 times increase in resolution).

In some examples, in a case that data B 250 includes a simulated thermal image for an artificial fusing layer (e.g., if t==L*T), the thermal image enhancement 252 may apply the first machine learning model 254 for each layer to generate an enhanced thermal image 262 (e.g., a high-resolution thermal image) corresponding to a fusing layer. The thermal image enhancement 252 may apply the fourth machine learning model 260 to generate an enhanced thermal image 262 (e.g., high-resolution thermal image) for each buried layer (e.g., each buried layer below the fusing layer corresponding to the artificial fusing layer). For example, the thermal image enhancement 252 may output K*T high-resolution thermal images, where for each of the K print layers, the thermal image enhancement 252 may report T enhanced thermal images 262 in a time sequence.

In some examples, an operation or operations may be performed based on the enhanced thermal image(s) 262. For example, control information may be determined based on the enhanced thermal image(s) 262. The control information may be utilized to print a layer or layers based on the enhanced thermal image(s) 262. For instance, the control information may indicate controlling the amount and/or location of fusing agent and/or detailing agent for a layer based on the enhanced thermal image(s) 262. In some examples, the control information may drive model setting (e.g., the size of the stride) based on the enhanced thermal image(s) 262. In some examples, the control information may indicate offline print mode tuning based on the enhanced thermal image(s) 262. For example, if the enhanced thermal image(s) 262 indicate systematic bias (e.g., a particular portion of the build area is consistently colder or warmer than baseline), the data pipeline may be altered such that the contone maps are modified to compensate for such systematic bias. For instance, if the enhanced thermal image(s) 262 indicates a systematic bias, the control information may indicate an adjustment to contone map generation (for a layer or layers, for example) to compensate for the bias. Accordingly, the location and/or amount of agent(s) deposited may be adjusted based on the contone map(s) to improve print accuracy and/or performance. In some examples, performing an operation may include presenting the enhanced thermal image(s) 262 on a display and/or sending the enhanced thermal image(s) 262 to another device.

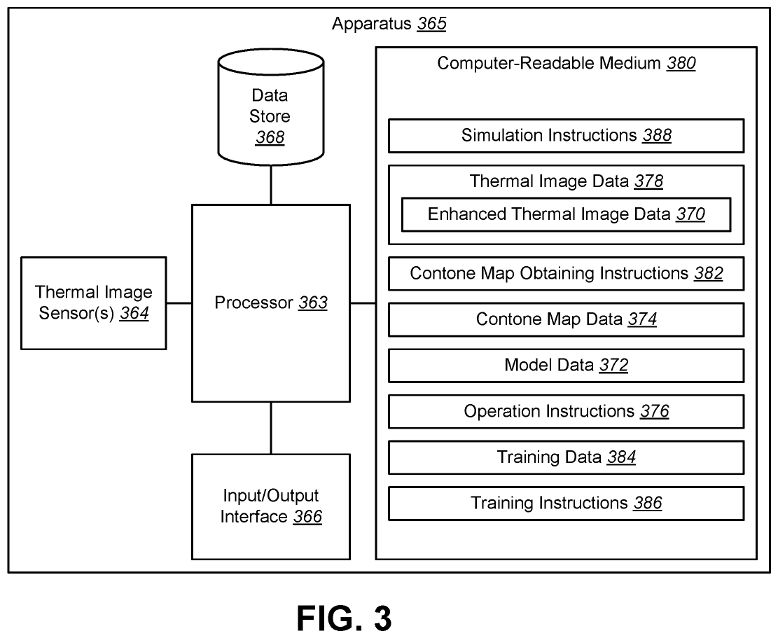

FIG. 3 is a block diagram of an example of an apparatus 365 that may be used in generating thermal images. The apparatus 365 may be a computing device, such as a personal computer, a server computer, a printer, a 3D printer, a smartphone, a tablet computer, etc. The apparatus 365 may include and/or may be coupled to a processor 363, a data store 368, an input/output interface 366, a computer-readable medium 380, and/or a thermal image sensor or sensors 364. In some examples, the apparatus 365 may be in communication with (e.g., coupled to, have a communication link with) an additive manufacturing device (e.g., the 3D printing device 100 described in connection with FIG. 1). In some examples, the apparatus 365 may be an example of the 3D printing device 100 described in connection with FIG. 1. For instance, the processor 363 may be an example of the controller 116 described in connection with FIG. 1, the data store 368 may be an example of the data store 114 described in connection with FIG. 1, and the thermal image sensor or sensors 364 may be an example of the thermal sensor 106 described in connection with FIG. 1. The apparatus 365 may include additional components (not shown) and/or some of the components described herein may be removed and/or modified without departing from the scope of this disclosure.

The processor 363 may be any of a central processing unit (CPU), a semiconductor-based microprocessor, graphics processing unit (GPU), FPGA, an application-specific integrated circuit (ASIC), and/or other hardware device suitable for retrieval and execution of instructions stored in the computer-readable medium 380. The processor 363 may fetch, decode, and/or execute instructions (e.g., operation instructions 376) stored on the computer-readable medium 380. In some examples, the processor 363 may include an electronic circuit or circuits that include electronic components for performing a functionality or functionalities of the instructions (e.g., operation instructions 376). In some examples, the processor 363 may perform one, some, or all of the functions, operations, techniques methods, etc., described in connection with one, some, or all of FIGS. 1-6.

The computer-readable medium 380 may be any electronic, magnetic, optical, or other physical storage device that contains or stores electronic information (e.g., instructions and/or data). Thus, the computer-readable medium 380 may be, for example, Random Access Memory (RAM), Electrically Erasable Programmable Read-Only Memory (EEPROM), a storage device, an optical disc, and the like. In some implementations, the computer-readable medium 380 may be a non-transitory tangible computer-readable medium, where the term “non-transitory” does not encompass transitory propagating signals.

The apparatus 365 may also include a data store 368 on which the processor 363 may store information. The data store 368 may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the computer-readable medium 380 may be included in the data store 368. In some examples, the computer-readable medium 380 may be separate from the data store 368. In some approaches, the data store 368 may store similar instructions and/or data as that stored by the computer-readable medium 380. For example, the data store 368 may be non-volatile memory and the computer-readable medium 380 may be volatile memory.

The apparatus 365 may further include an input/output interface 366 through which the processor 363 may communicate with an external device or devices (not shown), for instance, to receive and store the information pertaining to the object or objects to be manufactured (e.g., printed). The input/output interface 366 may include hardware and/or machine-readable instructions to enable the processor 363 to communicate with the external device or devices. The input/output interface 366 may enable a wired or wireless connection to the external device or devices. The input/output interface 366 may further include a network interface card and/or may also include hardware and/or machine-readable instructions to enable the processor 363 to communicate with various input and/or output devices, such as a keyboard, a mouse, a display, another apparatus, electronic device, computing device, etc., through which a user may input instructions into the apparatus 365.

In some examples, the computer-readable medium 380 may store thermal image data 378. The thermal image data 378 may be obtained (e.g., received) from a thermal image sensor or sensors 364 and/or may be generated. For example, the processor 363 may execute instructions (not shown in FIG. 3) to obtain a captured thermal image or images for a layer or layers. In some examples, the apparatus 365 may include a thermal image sensor or sensors 364, may be coupled to a remote thermal image sensor or sensors, and/or may receive thermal image data 378 (e.g., a thermal image or images) from a (integrated and/or remote) thermal image sensor. Some examples of thermal image sensors 364 include thermal cameras (e.g., infrared cameras). Other kinds of thermal sensors may be utilized. In some examples, thermal sensor resolution may be less than voxel resolution (e.g., each temperature readout may cover an area that includes multiple voxels). For example, a low-resolution thermal camera with a low-resolution (e.g., 31×30 pixels, 80×60 pixels, etc.) may be utilized. In other examples, a high-resolution thermal image sensor or sensors 364 may provide voxel-level (or near voxel-level) thermal sensing (e.g., 640×480 pixels) for machine learning model training.

The thermal image data 378 may include a thermal image or images. As described above, a thermal image may be an image that indicates heat (e.g., temperature) over an area and/or volume. For example, a thermal image may indicate a build area temperature distribution (e.g., thermal temperature distribution over a fusing layer). In some examples, the thermal image sensor or sensors 364 may undergo a calibration procedure to overcome distortion introduced by the thermal image sensor or sensors 364. For example, a thermal image may be transformed to register the thermal image with the contone map or maps. Different types of thermal sensing devices may be used in different examples.

In some examples, the processor 363 may execute contone map obtaining instructions 382 to obtain contone map data 374. For example, the contone map obtaining instructions 382 may generate a contone map or maps (e.g., from slice data and/or 3D model data) and/or may receive a contone map or maps from another device (via the input/output interface 366, for example). The contone map data 374 may indicate agent distribution (e.g., fusing agent distribution and/or detailing agent distribution) at the voxel level for printing a 3D object. For instance, the contone map data 374 may be utilized as per-layer machine instructions (e.g., voxel-level machine instructions) for agent distribution.

It should be noted that multiple different agent contone maps corresponding to different abilities to absorb or remove thermal energies may be utilized in some examples. Some examples may utilize different print modes where multiple contone maps may be used for each agent.

For a given layer (e.g., a current layer, a top layer, etc.), the contone map or maps of all agents deposited to the layer may be an energy driving force in some examples. It should be noted that another voxel-level energy influencer may include neighboring voxels in previous layers that may have a temperature differential compared to a given voxel, which may induce heat flux into or out of the voxel.

The computer-readable medium 380 may store model data 372. The model data 372 may include data defining and/or implementing a model or models (e.g., machine learning model or machine learning models). In some examples, the machine learning model(s) may include a neural network or neural networks. For instance, the model data 372 may define a node or nodes, a connection or connections between nodes, a network layer or network layers, and/or a neural network or neural networks. In some examples, the processor 363 may utilize (e.g., execute instructions included in) the model data 372 to calculate enhanced thermal images. An enhanced thermal image or images may be stored as enhanced thermal image data 370 on the computer-readable medium 380. In some examples, the first machine learning model 254, the second machine learning model 256, the third model 258, the fourth machine learning model 260 described in connection with FIG. 2 and/or variations thereof may be examples of the machine learning model(s) defined by the model data 372.

In some examples, the computer-readable medium 380 may include training instructions 386 and/or training data 384. The processor 363 may execute the training instructions 386 to train the machine learning model(s) using the training data 384. Training data 384 is data used to train the machine learning model(s). Examples of training data 384 may include simulated thermal data, shape images (e.g., slice(s) and/or contone map(s)), and/or thermal images (e.g., thermal images captured with a thermal sensor). In some examples, the training instructions 386 may be code to cause the processor 363 to train a machine learning model based on simulated thermal data.

In some examples, some thermal image data 378 and/or contone map data 374 may be included in the training data 384. For example, shape images (e.g., slices and/or contone maps) with a high resolution in a height dimension may be utilized as training data 384. In some examples, shape images may be obtained by slicing 3D model data of a build volume at various heights.

In some examples, the training data 384 may include simulated thermal data. Simulated thermal data is thermal data produced by a simulation. For example, the computer-readable medium 380 may include simulation instructions 388. The processor 363 may execute the simulation instructions 388 to produce the simulated thermal data. For example, the simulation instructions 388 may be code to cause the processor 363 to simulate 3D manufacturing to produce simulated thermal data at multiple resolutions. Examples of simulated thermal data may include a thermal map or thermal maps. A thermal map is a set of voxels or pixels that indicate temperature. Some examples of thermal maps with simulation voxel sizes, dimensions, and/or resolutions are given herein. Other simulation voxel sizes, dimensions, and/or resolutions may be used in some examples.

In some examples, the processor 363 may execute the simulation instructions 388 to produce simulated thermal data. For example, a simulation or simulations may be performed to produce high-resolution simulated thermal data to serve as ground truth data and low-resolution simulated thermal data to serve as input data for training the machine learning model(s). For instance, the processor 363 may execute the training instructions 386 to train the machine learning model(s) using the simulated thermal data. In some examples, the simulated thermal data may include an artificial fusing layer or layers and/or an artificial buried layer or layers.

In some examples, the processor 363 may execute the simulation instructions 388 to produce a first thermal map with a low resolution in height and/or a second thermal map with a high resolution in height (e.g., in the z dimension). For example, the simulated thermal data may include a first thermal map with a first height resolution and a second thermal map with a second height resolution that is greater than the first height resolution. In some examples, the simulated thermal data may be utilized to train the third model 258 and/or the fourth machine learning model 260 described in connection with FIG. 2.

In some examples, an entire horizontal area (e.g., x-y plane) over a height range (e.g., z dimension) of a build may be simulated. For example, a horizontal area of 284 mm×380 mm in size may be simulated over an 8 mm height range. The height range may be a portion of build height in some examples. For instance, two sets of simulation voxels may be generated: the first thermal map with simulation voxel dimensions of x=y=z=2 mm, and the second thermal map with simulation voxel dimensions of x=y=2 mm, z=0.08 mm. In some examples, simulated print time may be within a time range, such as 100*T, approximately 0.28 hours, or a production time of 100 layers. In some examples, these sets of simulation voxels, the first thermal map and/or the second thermal map, may be applied in training. For instance, the first thermal map may be utilized as an input and the second thermal map may provide a ground truth comparison for training the machine learning model(s).

In some examples, the processor 363 may execute the simulation instructions 388 to produce a second thermal map with a low x-y resolution and/or a third thermal map with a high x-y resolution. The second thermal map and/or the third thermal map may have a high resolution in height (e.g., in the z dimension). In some examples, the second thermal map and/or the third thermal map may be utilized to train the second machine learning model 256 described in connection with FIG. 2.

In some examples, a portion of a horizontal area (e.g., x-y plane) over a height range of a build may be simulated. For example, a portion of the horizontal area of 40 mm×60 mm in size may be simulated over an 8 mm height range. For instance, two set of simulation voxels may be generated: the second thermal map with simulation voxel dimensions of x=y=2 mm, z=0.08 mm, and the third thermal map with simulation voxel dimensions of x=y=0.169 mm, z=0.08 mm. In some examples, simulated print time may be within a time range, such as 100*T, approximately 0.28 hours, or a production time of 100 layers. In some examples, these sets of simulation voxels, the second thermal map and/or the third thermal map may be applied in training. For instance, the second thermal map may be utilized as an input and/or the third thermal map may provide a ground truth comparison for training the machine learning model(s). For example, the simulated thermal data may include a second thermal map with a second horizontal resolution and a third thermal map with a third horizontal resolution that is greater than the second horizontal resolution.

In some examples, the processor 363 may execute the simulation instructions 388 to produce the first thermal map with a low resolution in x-y and z and/or a fourth thermal map with a high x-y and z resolution. In some examples, the first thermal map and/or the fourth thermal map may be utilized to train a combination model of the first machine learning model 254 and the second machine learning model 256 described in connection with FIG. 2. In some examples, the first thermal map and/or the fourth thermal map may be utilized to train the first machine learning model 254 and/or the fourth machine learning model 260 described in connection with FIG. 2.

In some examples, an entire horizontal area (e.g., x-y plane) over a height range (e.g., z dimension) of a build may be simulated. For example, a horizontal area of 284 mm×380 mm in size may be simulated over an 8 mm height range. The height range may be a portion of build height in some examples. For instance, a set of simulation voxels may be generated: the fourth thermal map with simulation voxel dimensions of x=y=0.169 mm, z=0.08 mm. In some examples, simulated print time may be within a time range, such as 100*T, approximately 0.28 hours, or a production time of 100 layers. In some examples, this set of simulation voxels, the fourth thermal map, may be applied in training with first thermal map. For instance, the fourth thermal map and/or the first thermal map may be applied in training of combination model of the first machine learning model 254 and the second machine learning model 256 described in connection with FIG. 2. For instance, the first thermal map may be utilized as an input and the fourth thermal map may provide the ground truth. In some examples, the fourth thermal map may be applied in training for the first machine learning model 254 and/or the fourth machine learning model 260 described in connection with FIG. 2.

In some examples, the second machine learning model 256 may be trained as follows: a simulated thermal image and an image from the high-resolution shape images may be utilized as inputs. A simulated thermal image from the third thermal map may be utilized as ground truth.

In some examples, the third model 258 may be trained as follows: a simulated thermal image from the first thermal map and a sequence of shape images (e.g., 25 shape images corresponding to 25 layers) may be utilized as inputs. A sequence of simulated thermal images from the second thermal map may be utilized as ground truth.

In some examples, the first machine learning model 254 may be trained as follows: a sequence of simulated thermal images may be generated from the fourth thermal map or the third thermal map. The sequence of simulated thermal images for consecutive layers, when each of the layers is the fusing layer (e.g., with a different layer and different time t) and a sequence of contone maps (e.g., fusing agent contone maps and/or detailing agent contone maps) at consecutive layers may be utilized as inputs. In some examples, the first machine learning model 254 may be an un-supervised model, where a simulated thermal image corresponding to a next layer may be utilized as ground truth.

In some examples, the fourth machine learning model 260 may be trained as follows: a sequence of simulated thermal images may be generated from the fourth thermal map or the third thermal map in a format for machine learning model training. A sequence of simulated thermal images for a same layer at different times t and a sequence of simulated thermal images at same time t at different consecutive layers may be utilized as inputs. In some examples, a sequence of contone maps (e.g., fusing agent contone maps and/or detailing agent contone maps) at different consecutive layers may be utilized as an input. In some examples, the fourth machine learning model 260 may be an un-supervised model, where a simulated thermal image at a next time t+dt from the sequence of simulated thermal images may be utilized as ground truth.

In some examples, the processor 363 uses the trained machine learning model(s) (defined by the model data 372) to produce enhanced thermal image(s). For example, the processor 363 may enhance simulated thermal image(s) and/or captured thermal image(s) using the machine learning model(s) to produce an enhanced thermal image or images. The enhanced thermal image(s) may have an increased resolution relative to a resolution of the original simulated thermal image(s) and/or captured thermal image(s). The enhanced thermal image or images may be stored as enhanced thermal image data 370. For instance, the processor 363 may calculate (e.g., predict), using a machine learning model or machine learning models (e.g., deep network(s), neural network(s), etc.), the enhanced thermal image(s) corresponding to the print layer(s) based on the simulated thermal image(s), captured thermal image(s), and/or contone map(s).

An enhanced thermal image corresponding to a layer may be generated (e.g., predicted, calculated, and/or computed) before, at, or after a time that the layer is formed. In some examples, an enhanced thermal image may correspond to a layer that is subsequent to a layer corresponding to a captured thermal image. For example, the captured thermal image may correspond to a previous layer k−1 and the enhanced thermal image may correspond to a layer k. A number of captured thermal images of previous layers may also be utilized in the calculation in some examples. The contone map or maps may correspond to the same layer (e.g., layer k) as the layer corresponding to the enhanced thermal image and/or to a previous layer or layers.

In some examples, the enhanced thermal image may correspond to a layer that is the same as a layer corresponding to a captured thermal image. For example, a captured thermal image may correspond to a layer k and the enhanced thermal image may correspond to the layer k. It should be noted that a number of captured thermal images of previous layers may also be utilized in the calculation in some examples. The contone map or maps may correspond to the same layer (e.g., layer k) as the layer corresponding to the enhanced thermal image and/or to a previous layer or layers.

In some examples, the processor 363 may execute the operation instructions 376 to perform an operation based on the enhanced thermal image(s). For example, the processor 363 may print (e.g., control amount and/or location of agent(s) for) a layer or layers based on the enhanced thermal image(s). In some examples, the processor 363 may drive model setting (e.g., the size of the stride) based on the enhanced thermal image(s). In some examples, the processor 363 may perform offline print mode tuning based on the enhanced thermal image(s). In some examples, the processor 363 may send a message (e.g., alert, alarm, progress report, quality rating, etc.) based on the enhanced thermal image(s). In some examples, the processor 363 may halt printing in a case that the enhanced thermal image(s) indicate or indicates an issue (e.g., more than a threshold difference between a layer or layers of printing and the 3D model and/or slices). In some examples, the processor 363 may feed the enhanced thermal image for the upcoming layer to a thermal feedback control system to online compensate the contone maps for the upcoming layer.

Some examples of the techniques described herein may provide resolution enhancement that is 5 to 10 times the resolution of simulated thermal images. This approach may enable real-time in-situ thermal image prediction and feedback control. For example, the machine learning model architecture may enable the real-time in-situ fusing layer thermal prediction with print resolution and/or online closed-loop thermal feedback control.

In some examples, the computer-readable medium 380 may store 3D model data (not shown in FIG. 3). The 3D model data may be generated by the apparatus 365 and/or received from another device. In some examples, the computer-readable medium 380 may include slicing instructions (not shown in FIG. 3). For example, the processor 363 may execute the slicing instructions to perform slicing on the 3D model data to produce a stack of two-dimensional (2D) vector slices.

In some examples, the operation instructions 376 may include 3D printing instructions. For instance, the processor 363 may execute the 3D printing instructions to print a 3D object or objects. In some implementations, the 3D printing instructions may include instructions for controlling a device or devices (e.g., rollers, print heads, and/or thermal projectors, etc.). For example, the 3D printing instructions may use a contone map or contone maps (stored as contone map data, for instance) to control a print head or heads to print an agent or agents in a location or locations specified by the contone map or maps. In some examples, the processor 363 may execute the 3D printing instructions to print a layer or layers. The printing (e.g., thermal projector control) may be based on thermal images (e.g., captured thermal images and/or predicted thermal images).

In some examples, the processor 363 may execute the training instructions 386 to train the machine learning model(s) (e.g., a neural network or neural networks) using a loss function. For example, the training instructions 386 may include a loss function. The processor 363 may compute the loss function based on an enhanced thermal image and a simulated thermal image for training. For example, the simulated thermal image for training may provide the ground truth (which may be at a high resolution) to calculate the loss function. The loss function may be utilized to train the machine learning model(s). For example, a node or nodes and/or a connection weight or weights in the machine learning model(s) (e.g., neural network(s)) may be adjusted based on the loss function in order to improve the prediction accuracy of the machine learning model(s). In some examples, not all of the operations and/or features described in connection with FIG. 3 may be utilized and/or implemented.

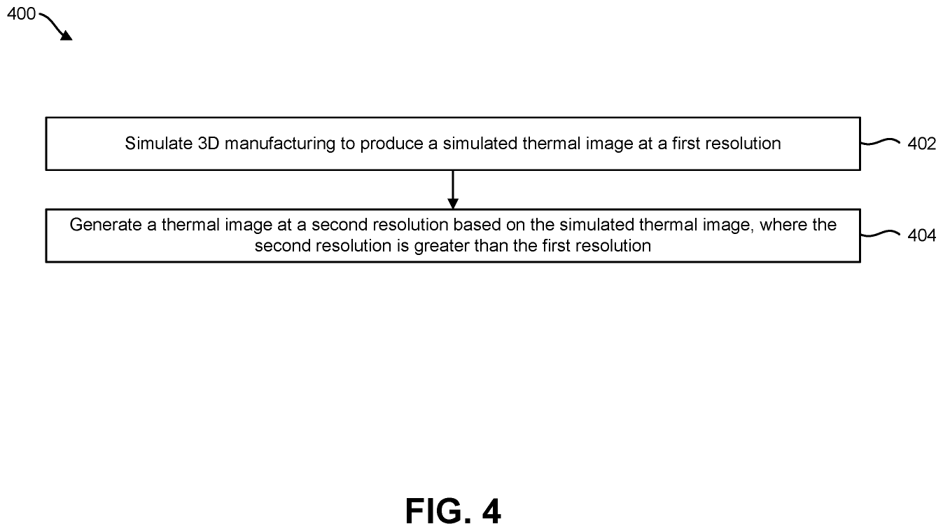

FIG. 4 is a flow diagram illustrating an example of a method 400 for generating thermal images. The method 400 and/or an element or elements of the method 400 may be performed by an electronic device. For example, the method 400 may be performed by the apparatus 365 described in connection with FIG. 3 and/or by the 3D printing device 100 described in connection with FIG. 1.

The apparatus 365 may simulate 402 3D manufacturing to produce a simulated thermal image at a first resolution. In some examples, this may be accomplished as described in connection with FIG. 1, FIG. 2, and/or FIG. 3. For example, the apparatus 365 may utilize 3D model data, slice(s), and/or contone map(s) to produce the simulated thermal image. In some examples, the first resolution may be a low resolution.

The apparatus 365 may generate 404 a thermal image at a second resolution based on the simulated thermal image, where the second resolution is greater than the first resolution. In some examples, this may be accomplished as described in connection with FIG. 1, FIG. 2, and/or FIG. 3 above. The thermal image at the second resolution may be an enhanced thermal image. For example, the second resolution may be a high resolution.

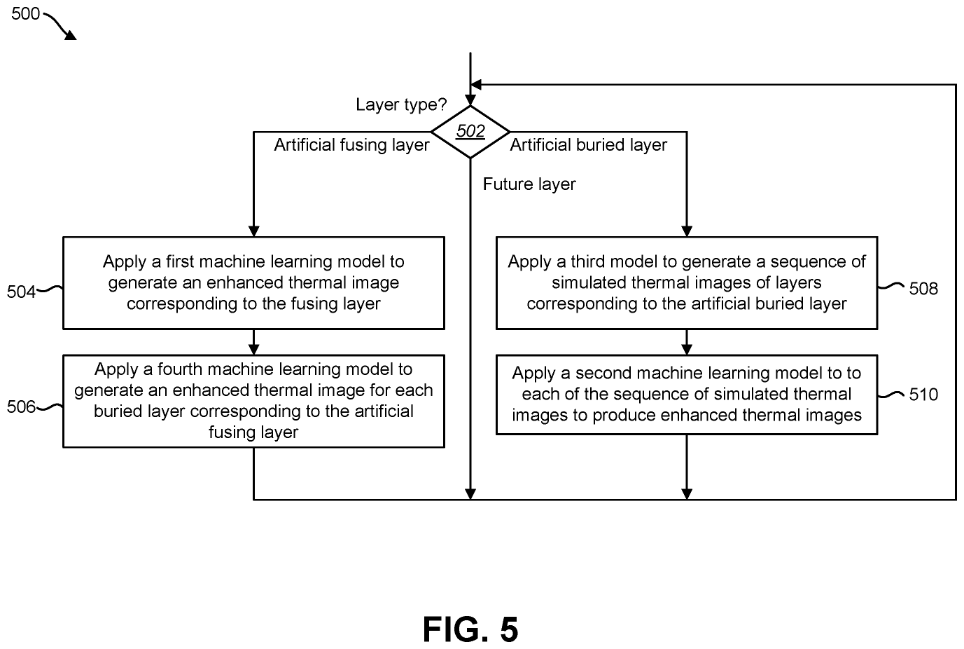

FIG. 5 is a flow diagram illustrating an example of a method 500 for generating thermal images. In some examples, generating a thermal image (e.g., enhanced thermal image) may include performing an element or elements of the method 500. The method 500 and/or an element or elements of the method 500 may be performed by an electronic device. For example, the method 500 may be performed by the apparatus 365 described in connection with FIG. 3 and/or by the 3D printing device 100 described in connection with FIG. 1.

The apparatus 365 may determine 502 a layer type corresponding to a simulated thermal image. A layer type indicates a future layer, an artificial fusing layer, or an artificial buried layer. For example, the apparatus 365 may determine 520 whether a simulated thermal image corresponds to a future layer, to an artificial fusing layer, or to an artificial buried layer. An artificial fusing layer may correspond to a fusing layer and a buried layer or layers (e.g., buried layers under the fusing layer). An artificial buried layer may correspond to buried layers. In some examples, simulated thermal images may be processed differently depending on whether a simulated thermal image corresponds to an artificial fusing layer or an artificial buried layer.

In some examples, the determination 502 may be based on a time t, a layer L, and a production time per layer T. For instance, if t<L*T, then the simulated thermal image corresponds to a future layer, if t>L*T, then the simulated thermal image corresponds to an artificial buried layer, or if t==L*T, then the simulated thermal image corresponds to an artificial fusing layer.

In a case that the simulated thermal image corresponds to a future layer, then operation may return to the determination 502. For example, the determination 502 may be performed for a next layer.

In a case that the simulated thermal image corresponds to an artificial fusing layer, the apparatus 365 may apply 504 a first machine learning model to generate an enhanced thermal image corresponding to a fusing layer. In some examples, this may be accomplished as described in connection with FIG. 2. For example, generating a thermal image at a second resolution that is higher than the first resolution of the simulated thermal image may include applying the first machine learning model for a fusing layer.

In a case that the simulated thermal image corresponds to an artificial fusing layer, the apparatus 365 may apply 506 a fourth machine learning model to generate an enhanced thermal image for each buried layer corresponding to the artificial fusing layer. In some examples, this may be accomplished as described in connection with FIG. 2. For example, generating a thermal image at a second resolution that is higher than the first resolution of the simulated thermal image may include applying the fourth machine learning model for a buried layer.

In a case that the simulated thermal image corresponds to an artificial buried layer, the apparatus 365 may apply 508 a third model to generate a sequence of simulated thermal images (e.g., low-resolution simulated thermal images) of layers corresponding to the artificial buried layer. In some examples, this may be accomplished as described in connection with FIG. 2. For example, the third model may produce a sequence of simulated thermal images based on the artificial buried layer and a sequence of shape images. In some examples, the third model may include a sequence generator and a spatiotemporal model.

The apparatus 265 may apply 510 a second machine learning model to each of the sequence of simulated thermal images to produce enhanced thermal images. In some examples, this may be accomplished as described in connection with FIG. 2. For example, the second machine learning model may be applied to one of the sequence of simulated thermal images to produce a thermal image at a second resolution that is higher than a first resolution of the simulated thermal image.

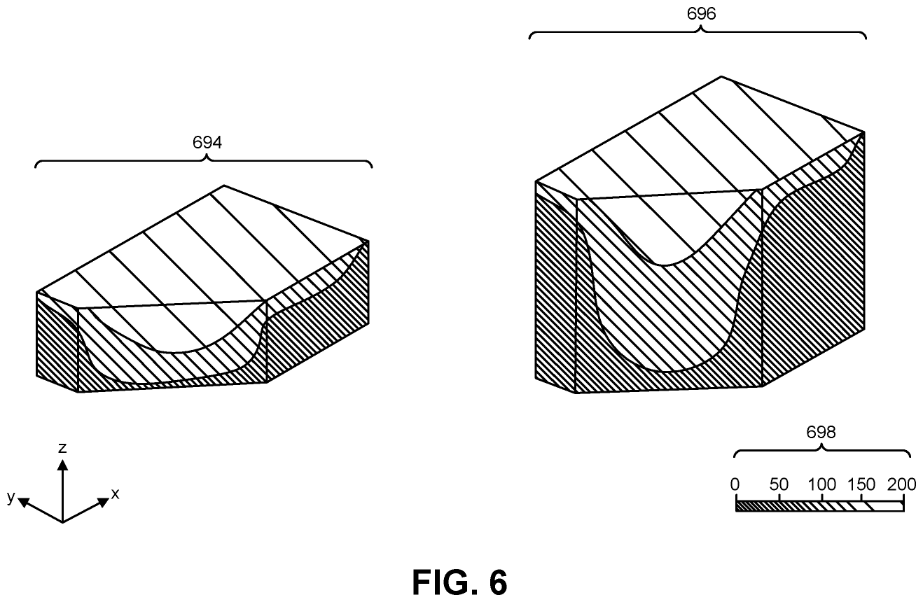

FIG. 6 is a simplified perspective view of an example of visualizations 694, 696 of simulation results in accordance with some examples of the techniques described herein. Some examples of the simulation described herein include a simulation of a transient manufacturing (e.g., printing) procedure. The simulation may produce a transient temperature history for each voxel as simulation results. The visualizations 694, 696 are simplified temperature maps corresponding to a build volume at different times. For example, the first visualization 694 illustrates simulation results of 3D manufacturing at a first time, and the second visualization 696 illustrates simulation results of the 3D manufacturing at a second later time. Both of the visualizations 694, 696 include cutaways to illustrate internal temperatures (e.g., buried layers). In this example, the temperatures are illustrated on a simplified scale in degrees Fahrenheit 698. Other examples may be presented on a color gradient scale to show finer temperature variation than the example in FIG. 6.

In some examples, visualizations of simulation results may be presented on a display and/or simulation results may be sent to another device (e.g., computing device, monitor, etc.) to present visualizations of simulation results. In the example illustrated in FIG. 6, the simulation reflects manufacturing where objects are built up layer by layer.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
simulating three-dimensional (3D) manufacturing to produce a simulated thermal image at a first resolution; and
generating a thermal image at a second resolution based on the simulated thermal image, wherein the second resolution is greater than the first resolution.

2. The method of claim 1, wherein in a case that the simulated thermal image corresponds to an artificial fusing layer, generating the thermal image at the second resolution comprises applying a first machine learning model for a fusing layer.

3. The method of claim 1, wherein in a case that the simulated thermal image corresponds to an artificial fusing layer, generating the thermal image at the second resolution comprises applying a fourth machine learning model for a buried layer.

4. The method of claim 1, wherein in a case that the simulated thermal image corresponds to an artificial buried layer, generating the thermal image at the second resolution comprises applying a third model to produce a sequence of simulated thermal images of layers corresponding to the artificial buried layer.

5. The method of claim 4, wherein the third model produces the sequence of simulated thermal images based on the artificial buried layer and a sequence of shape images.

6. The method of claim 4, further comprising applying a second machine learning model to one of the sequence of simulated thermal images to produce the thermal image at the second resolution.

7. The method of claim 4, wherein the third model comprises a sequence generator and a spatiotemporal model.

8. The method of claim 1, further comprising determining a layer type corresponding to the simulated thermal image.

9. The method of claim 8, wherein determining the layer type is based on a time, a layer, and a production time per layer.

10. The method of claim 8, wherein the layer type indicates a future layer, an artificial fusing layer that corresponds to a fusing layer and first buried layers, or an artificial buried layer that corresponds to second buried layers.

11. A three-dimensional (3D) printing device, comprising:
a print head;
a thermal projector;
a thermal sensor; and
a controller, wherein the controller is to:
produce a simulated thermal image corresponding to an artificial layer, wherein the artificial layer corresponds to multiple print layers; and
generate a set of enhanced thermal images based on the simulated thermal image, wherein each of the set of enhanced thermal images corresponds to one of the multiple print layers.

12. The 3D printing device of claim 11, wherein the controller is to generate the set of enhanced thermal images based on machine learning models.

13. A non-transitory tangible computer-readable medium storing executable code, comprising:
code to cause a processor to simulate three-dimensional (3D) manufacturing to produce simulated thermal data at multiple resolutions; and
code to cause the processor to train a machine learning model based on the simulated thermal data.

14. The computer-readable medium of claim 13, wherein the simulated thermal data comprises a first thermal map with a first height resolution and a second thermal map with a second height resolution that is greater than the first height resolution.

15. The computer-readable medium of claim 14, wherein the simulated thermal data comprises a first thermal map with a first horizontal resolution and a second thermal map with a second horizontal resolution that is greater than the first horizontal resolution.
